(19) United States
(12) Patent Application Publication
(10) Pub. No.: US 2013/0282597 A1
(43) Pub. Date: Oct. 24, 2013

(54) APPARATUS AND METHOD FOR SOLID AND HAZARDOUS WASTE MANAGEMENT

(71) Applicant: Marty M. Martin, Fort Worth, TX (US)

(72) Inventor: Marty M. Martin, Fort Worth, TX (US)

(73) Assignee: Safety-Kleen Systems, Inc., Norwell, MA (US)

(21) Appl. No.: 13/826,668

(22) Filed: Mar. 14, 2013

Related U.S. Application Data
(60) Provisional application No. 61/637,140, filed on Apr. 23, 2012.

(51) Int. Cl. G06Q 10/00

(52) U.S. Cl. CPC G06Q 10/30
USPC 705/308

(57) ABSTRACT

A system for managing, sorting, storing and removing/disposing of solid and hazardous waste in products may include scanner logic that is operatively capable of obtaining product ID information representative of a damaged product and waste logic that is operative capable of generating waste information based on the product ID information. The scanner logic may be further operative to print a waste instruction label that instructs a user as to how to dispose of the damaged product.

### RELATED APPLICATIONS

This application is based on and claims priority to provisional U.S. Patent Application No. 61/637,140, filed Apr. 23, 2012, the contents of which are herein incorporated by reference.

### FIELD OF THE DISCLOSURE

The present disclosure generally relates to the management of solid and hazardous waste, and more particularly, to managing, sorting, storing and removing/disposing solid and hazardous waste in products.

### BACKGROUND OF THE DISCLOSURE

In the United States, the storage, handling, treatment, transportation and disposal of solid and hazardous waste is governed by federal, state and local law and regulations. For example, at the federal level, several laws, Presidential Executive Orders and regulations are enforced by the Environmental Protection Agency (“EPA”) including, but not limited to, the Resource Conservation and Recovery Act, 42 U.S.C. §§6901, et seq. (the “RCRA”)¹, the RCRA Regulations, 40 C.F.R. Parts 260-265, 122-124 (the “RCRA Regulations”) and the Clean Water Act, 33 U.S.C. §§1251 et seq. (the “CWA”), the Occupational Health & Safety Administration including, but not limited to the Occupational Health & Safety Act, 29 U.S.C. §§651 et seq. (“OSHA”), the OSHA Regulations, 29 C.F.R. Part 1910 et seq., etc. Many states and local governments have similarly enacted laws and regulations that are at least as stringent as federal laws and regulations. For example, the California Code includes the California Health and Safety Code (the “CHSC”). Likewise, the Texas Code includes the Texas Water Code (the “TWC”) and the Texas Health and Safety Code (the “THSC”). Other federal, presidential executive orders state and local laws and regulations governing the storage, handling, transportation and disposal of solid hazardous waste exist. The RCRA, the RCRA Regulations, the CWA, the CHSC, the THSC and the TWC are hereby incorporated herein by reference. ¹Amending the Solid Waste Disposal Act of 1965, the RCRA was enacted in 1976 as the principal federal law governing the disposal of solid waste and hazardous waste. In particular, Congress enacted the RCRA to address problems resulting from an increase in municipal and industrial waste.

While the foregoing laws, orders and regulations (collectively, “Health and Safety Laws”) offer their own definitions of solid waste and/or hazardous waste, examples of materials that are generally understood to include solid and/or hazardous waste are: pesticides, certain chemicals, paints, aerosols, acids, fertilizers, motor oil, flammable liquids, propone canisters, light bulbs containing mercury, corrosive spray cleaners, medical waste, toxins, oven cleaners, bleaches, chlorine, pool chemicals and cleaners, batteries, jewelry cleaners, etc.

Companies are required to comply with extant Health and Safety Laws to ensure that hazardous waste will not end up at local landfills where toxic chemical can seep into water supplies or emit dangerous gases. In particular, retailers must ensure that products containing solid and/or hazardous waste that are expired, returned, damaged, recalled or otherwise cannot be sold (collectively, “Damaged Products”) are properly managed, sorted, stored, and disposed of in compliance with Health and Safety Laws. Failure to comply with Health and Safety Laws exposes a company to significant fees and punishment as the EPA, other governmental agencies and other law enforcement personnel have repeatedly warned that companies, regardless of their size, will not be allowed to flaunt environmental laws and that such environmental laws. Big box retailers have been fined as much as $27 Million Dollars in recent years for violations of Healthy and Safety laws.

Currently, big box retailers and other companies comply with Health and Safety laws by storing Damaged Products in large bins and engaging licensed hazardous waste disposal companies, service providers or the like (“Hazardous Waste Haulers”) to regularly pick up such containers, sort the Damaged Products and properly dispose and/or treat such Damaged Products in accordance with applicable law.

While the process described above is one solution for complying with Health and Safety Laws, it is time consuming, costly, and still exposes companies to violations. For example, sorting a large container of Damaged Products can be significantly more time consuming and costly than the real time and proper sorting of Damaged Products into separate containers, each such container being designated for a particular category of Damaged Products. Many companies, however, are not well equipped to sort Damaged Products in real time due to the resources and expertise required. For example, the appropriate sorting of Damaged goods requires detailed knowledge of Health and Safety Laws and composition for Damaged Products.

Similarly, companies that simply place Damaged Products in the same bin for pick up by Hazardous Waste Haulers ignore storage laws and regulations that require certain Damaged Products to be stored separately from certain other Damaged Products to avoid a potential adverse reaction between underlying components (e.g., chemicals). For example, a Damaged Product may, unbeknownst to a company, be leaking chlorine that can react with certain other chemicals causing toxic fumes to be emitted into the atmosphere.

Consequently, there exists a need for a new solution for storage, handling, treatment, transportation and disposal of solid and hazardous waste that is compliant with extant Health and Safety laws and that is more efficient, less costly, and less time consuming than current practices.

### BRIEF DESCRIPTION OF THE DRAWINGS

The invention will be more readily understood in view of the following description when accompanied by the below figures and wherein like reference numerals represent like elements.

FIG. 1 illustrates a block diagram of an exemplary system for solid and hazardous waste management in accordance with one embodiment of the present disclosure;

FIG. 2 illustrates a block diagram of the scanner device and waste logic of FIG. 1;

FIG. 3 illustrates an exemplary waste instruction label in accordance with one embodiment of the present disclosure; and

FIG. 4 illustrates exemplary labeled waste receptacles in accordance with one embodiment of the present disclosure.

### DETAILED DESCRIPTION

As used herein, the following terms have the meanings ascribed thereto as set forth below. A “processor” may refer to any number of physical devices or components that is/are capable of processing (e.g., performing a variety of operations on) information (e.g., information in the form of binary data or carried/represented by any suitable media, signal, etc.). For example, a processor may include a desktop computer, a laptop computer, a mobile device, a hand-held device, a server (e.g., a file server, a web server, a program server or any other server), a microprocessor, a microcontroller, a sequencer, a microsequencer, a digital signal processor, a digital signal processor, a processing engine, a hardware accelerator, a application specific circuit (ASIC), a state machine, a programmable logic array, an integrated circuit, a discrete circuit, etc., or any combination thereof. An example of a processor may be one or more integrated circuits comprising transistors that are programmed or configured to perform a particular task. A processor may include a general purpose processor that is executing executable instruction stored in memory that cause the general purpose processor to perform specific tasks (i.e., a programmed general purpose processor).

“Memory” may refer to any suitable violate or non-volatile memory, memory device, memory chip(s), or storage device or chip(s) such as, but not limited to system memory, frame buffer memory, flash memory, random access memory (RAM), read-only memory (ROM), a register, a latch, or any combination of the above. “Executable instructions” may refer to software or firmware programs or instructions or any other suitable instructions or commands capable of being processed by a suitable processor. “Logic” may refer to any single or collection of circuits, integrated circuits, processors, transistors, memory, executable instructions, databases, combination logic circuit, or any combination of the above that is capable of providing a desired operation(s) or function(s). For example, logic may take the form of a processor executing instructions from memory or a dedicated integrated circuit. A “communication link” may refer to any media through which signals, data or other information may be communicated. For example, a communication link may include one or more wires, busses, cables, infra-red signals, waveforms (e.g., a wireless path), network routers, hubs, etc., and any combination of the above. A “display” may refer to any device or component of a device that is capable of visually reproducing visual information or data such as, but not limited to a CRT, a LCD or plasma display device. “Information” may include data (analog or digital), signal(s) (analog or digital), or any other indicator(s).

In the following detailed description, numerous specific details are set forth in order to provide a thorough understanding the present disclosure. It will be apparent to one of ordinary skill in the art, however, that these specific details need not be used to practice the present disclosure. In other instances, well-known structures, interfaces and processes have not been shown or described in detail in order to avoid obscuring the instant disclosure.

FIG. 1 illustrates a block diagram of an exemplary system 100 for managing solid and hazardous waste management in accordance with one embodiment of the present disclosure. System 100 includes scanner device 102 and waste logic 106. Scanner device 102 may be any conventional scanner that is capable of identifying a product. For example, scanner device 102 may constitute a conventional barcode scanner, RFID scanner or other device with similar functionality or the like. As illustrated by process arrow 118, scanner device 102 operates to identify or generate product identification information 122 associated with a Damaged Product 108 and communicates the product identification information 122 to waste logic 106. Product identification information 122 is any suitable information that uniquely identifies the Damaged Product 108. Product ID information 122 may, for example, constitute barcode information, RF ID tag information or other identification scheme, methodology or functionality or the like. Product ID information 122 may also include Scanner Device ID information.

As illustrated, scanner device 102 may communicate with waste logic 106 over the Internet 104 using various communication links 114, 116 as is known in the art. For example, communication links 114, 116 may include wired and wireless communication links. Although described herein as a remote component in the system and as being managed by a third party (e.g., a Hazardous Waste Hauler), waste logic 106 may alternately reside locally either within the scanner device 102 itself or on the same network or system as the owner/leasee or user of the scanner device 102 (e.g., the waste logic 106 may be a local component).

In operation, waste logic 106 associates the product ID information 122 read and/or generated by the scanner device 102 with specific waste information 124 and communicates the specific waste information 124 back to the scanner device 102. Waste information 124 may comprise a variety of information such as but not limited to one or more of the following or information that represents one or more of the following: the identity of the Scanner Device 102 owner/leasee or owners, the product ID information 122 for the Damaged Product 108 (e.g., the barcode), the product name of the Damaged Product 108, a description or classification of the Solid Waste and/or Hazardous Waste contained within the Damaged Product 108, and instructions for how to handle, store, treat, transport and/or dispose of the Damaged Product 108. To the extent the waste information 124 is merely representative of the detailed information identified above, scanner device 102 may generate or obtain the detailed information internally as described below with respect to scanner device logic. Occasionally, a retailer may add new products to its inventory of existing products for which specific waste information 124 is already associated with the respective product ID information 122. As a result, specific waste information 124 for the applicable Product ID information 122 (i.e., new product in inventory) is not present in the waste logic 106. Accordingly, in one embodiment, such as when there is no specific waste information 124 associated with the applicable Product ID information 122, the waste logic 106 may be configured to communicate with the Hazardous Waste Hauler or its service providers or designees to provide notice of such missing information and with the scanner device 102 to provide instructions to hold the Damaged Product 108 associated with the applicable Product ID information 122 (new) in a segregated area away from other Damaged Products 108. Preferably, the Hazardous Waste Hauler may then update the waste logic 106 with the applicable specific waste information 124 for such applicable Product ID information 122 (new), so that when the new Damaged Product 108 is removed from the segregation area and re-scanned or read, the applicable specific waste information 124 is communicated to the scanner device 102 in accordance with this disclosure.

Scanner device 102 then prints out a waste instruction label 110 based on the waste information 124. As illustrated in FIG. 3, waste instruction label 110 may include one or more of the following: the current date and time 302, the company name or identifier 304 (e.g., the name of the big box retailer), the employee name or identifier 306 (e.g., the operator of the scanner device 102), product ID information 308 (e.g., the barcode), the product name or identifier 310, the waste description (e.g., an EPA or other regulatory classification) 312, and waste instructions 314. It is contemplated that other information 316 may also be included within a waste instruction label 110.

Waste instructions 314 may include instructions relating to, for example, the handling, storage, treatment, transportation and/or disposal of Damaged Products 108. For example, Waste instructions 314 may include any meaningful instructions to the operator such as “wear goggles and latex gloves”, “store for no longer than two weeks”, “treat in a chemical bath prior to disposal”, “transport only in certain licensed vehicles”, etc. Waste instructions 314 may also include an indicator such as a color that has a pre-defined meaning For example, a certain color may be associated with a waste container 112 where Damaged Products 108 that are identified as corresponding to that color should be placed and stored.

Waste instructions 314 are preferably compliant with extant Health and Safety Laws and any other specific requirements of the Hazardous Waste Haulers and/or operators of the scanning device 102. Those of skill in the art will recognize that any number of different instructions and information may be communicated on the waste instruction label 110. For example, an operator of the Scanner Device 102 may choose to further sort certain Damaged Products 102 beyond what is required by Health and Safety Laws.

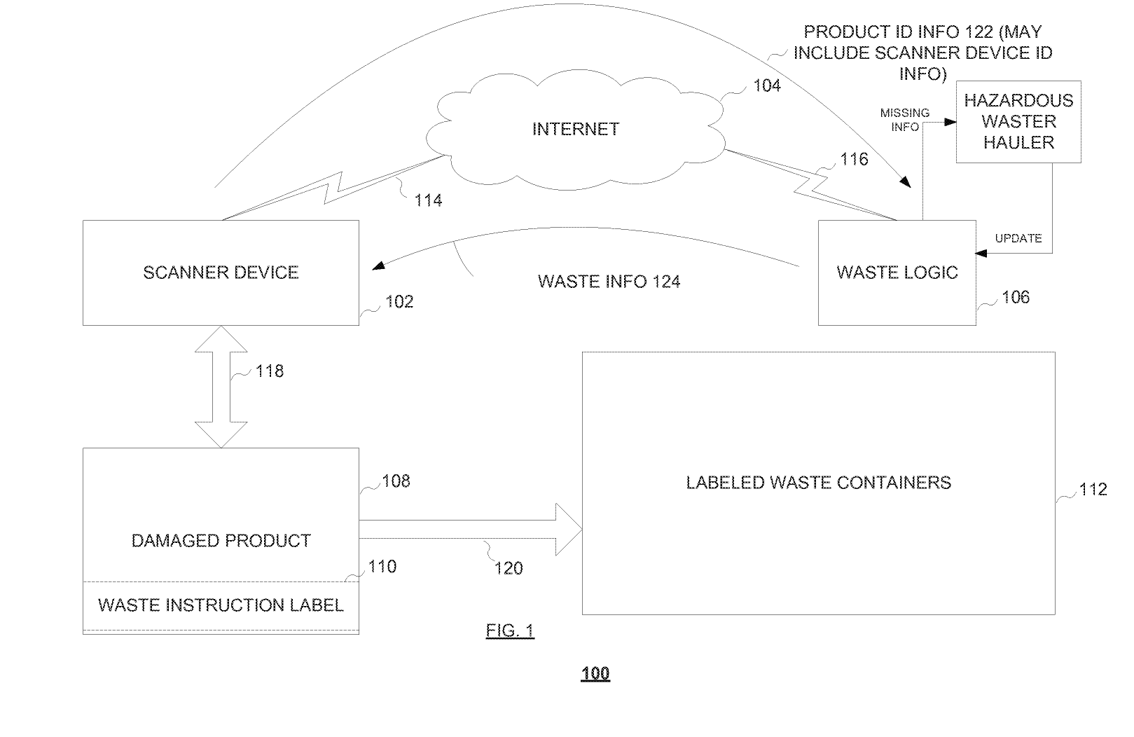

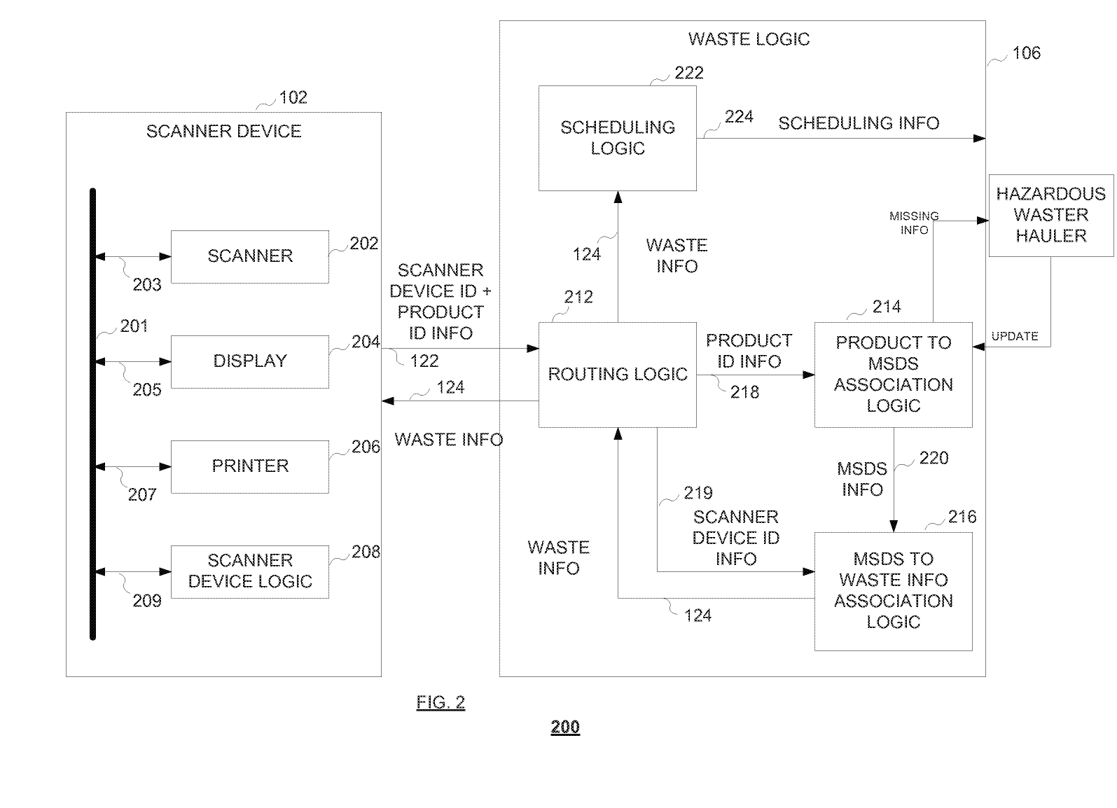

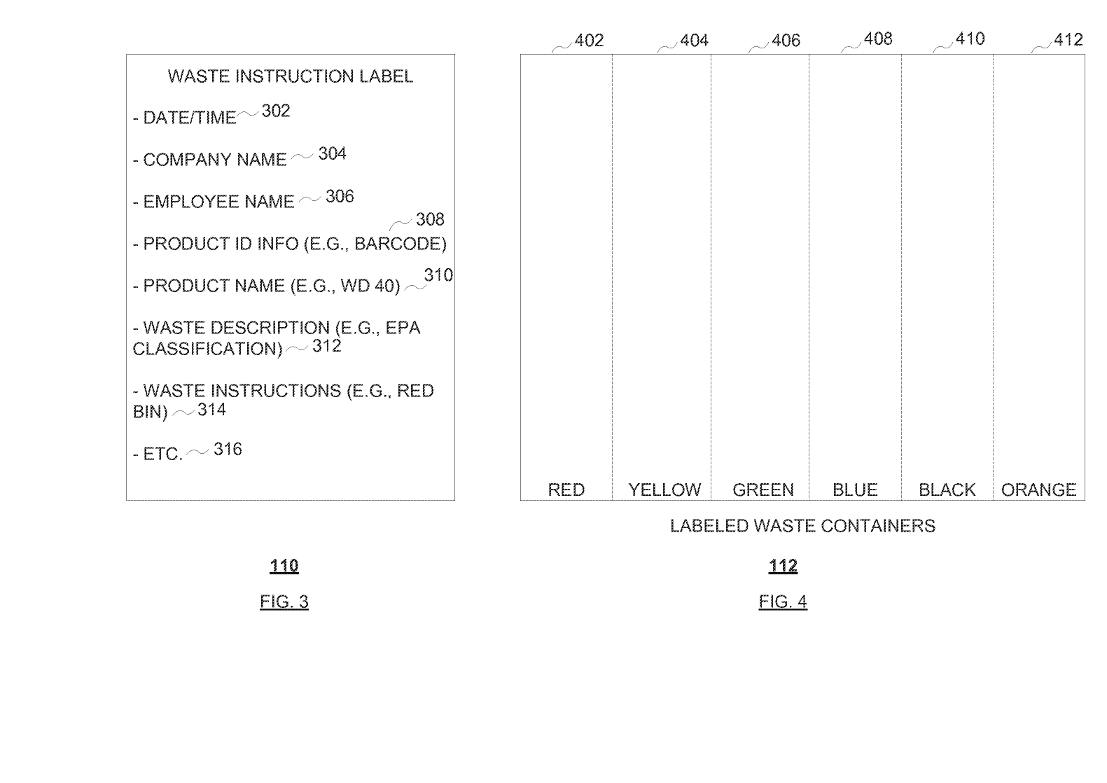

As illustrated by process arrows 118, 120, the printed waste instruction label 110 may be applied to the waste product 108 and an operator of the scanner device 102 may simply follow the directions printed on the waste instruction label 110 for proper handling, storage, treatment, transportation and/or disposal of the Damage Product 108. For example, the waste instruction label 110 may include waste instructions 314 that includes an identifier, such as, for example only, a color, mark, symbol, number, etc. or the like or any combination of the foregoing, that corresponds to a container 112 where the Damaged Product 108 should be stored until pick up by Hazardous Waste Haulers. For example and with reference to FIG. 4, if the waste instruction label 110 includes the identifier which is the color green as part of the waste instructions 314, then the Damaged Product should be placed in container 406 that is labeled “green”. Other containers 112 may exist for other colors associated with different types of Damaged Products. For example, there may exist a red container 402, a yellow container 404, a blue container 408, a black container 410 and an orange container 412, etc. One of skill in the art will recognize that other similar identification strategies or schemes may be employed with other colors, marks, symbols, numbers, etc. or the like or any combination of the foregoing.

FIG. 2 illustrates a block diagram of the scanner device 102 and waste logic 106 of FIG. 1. Scanner device 102 includes a scanner 202 such as a barcode scanner or an RF ID scanner or any other scanner that is capable of identifying a Damaged Product 108 by an identifier. Scanner device 102 also includes a display 204 such as a liquid crystal display or any other suitable display. Scanner device 102 includes a printer 206 and scanning device logic 208 capable of supporting scanner 202, display 204, printer 206 and otherwise capable of providing the functionality of the scanner device 102 as described herein. Each of scanner 202, display 204, printer 206 and scanning device logic 208 is coupled to, for example a system bus 201 through communication links 203, 205, 207 and 209. Other architectures, however, are contemplated.

Waste logic 106 includes routing logic 212 that is capable of receiving and transmitting information with the scanning device 102 and is further capable of routing such received information to other components that make up the waste logic 106. Waste logic 106 further includes Product to Safety Data Sheet (“SDS”) Association Logic 214. Product to SDS association logic is logic that is capable of associating the product ID information 122 of a given Damaged Product 108 with the corresponding Damaged Product's SDS or with information corresponding to or identifying the Damaged Product's SDS. As is known in the art, a SDS is a data sheet that provides workers and emergency personnel with procedures for handling or working with that product/substance in a safe manner. SDS's include information such as physical data (e.g., melting point, boiling point, flash point, etc.), toxicity, health effects, first aid, reactivity, storage, disposal, protective equipment and spill-handling procedures. One of skill in the art will recognize that SDS will include any document referred to as a Material Safety Data Sheets, Safety Data Sheets or any similar document that complies with OSHA's Hazard Communication Standard, 29 CFR 1910.1200 or the like, and all will be referred to herein as SDS. Each Damaged Product 108 is associated with a unique SDS.

Waste logic 106 further includes SDS to Waste Info Association Logic 216. SDS to Waste Info association logic 216 is logic that is capable of associating SDS info 220 with particular waste information 124 or with information corresponding to or identifying particular waste information. In one embodiment, the Scanner Device 102 further transmits scanner device ID information as part of the Product ID information 122. Routing logic 212 routes the Product ID information component 218 to the product to SDS association logic 214 and routes the scanner device ID information component 219 to the SDS to waste info association logic 216. SDS to waste info association logic 216 generates the waste info 124 based on the scanner device ID information 219 and the SDS information 220.

In other words, the waste information 124 (and the waste instructions labels 110) may be unique to each owner/lease or user of the scanner device 102. For example, retailers that do sell certain product lines may be able to store Damaged Products differently in accordance with Health and Safety Laws than retailers that carry different product lines. In particular, it is contemplated that the same product might be sold at a pharmacy, an automotive supply store, a hardware store and a grocery store. To the extent the product becomes a Damaged Product, Health and Safety Laws may require the hypothetical product to be stored with vastly different products and in a different waste container 112 at each store.

Routing Logic 212 receives the generated disposal information 124 and routes it both to the scanner device 102 and to scheduling logic 222. Upon receipt of the waste information 124, scanner device 102 prints waste instruction label 110 based on the waste information 124 using, for example scanner device logic 208 to associate or otherwise generate the waste instruction label 110 based on the waste information 124. For example, waste information 124 may simply include a numeric code and scanning device logic 208 may be able to associate the numeric code with the correct waste instruction label 110 corresponding thereto.

Scheduling logic 222 also receives the waste information 124 and operates to generate scheduling information 224 that indicates when the Hazardous Waste Hauler should be dispatched to pick up collected Damaged Products for the particular entity using the Scanning Device 102. For example, scheduling logic 222 may keep track of the degree to which waste containers 112 are full based on the waste information 124 that it receives and based on other criteria (e.g., the size of the containers 112, the size of the Damaged Product 108, historical data, etc.) By tracking the waste information 124, scheduling logic 222 can predict when the Hazardous Waste Hauler should be dispatched. Similarly, scheduling logic 222 may operate to dispatch the Hazardous Waste Hauler based on a schedule (e.g., a predetermined schedule) or based on Health and Safety Law requirements.

Waste logic 106 may be operated locally to a specific Hazardous Waste Hauler or, alternatively, may be operated by a scheduler associated with more than one Hazardous Waste Hauler. As such scheduling information 224 may be directed to either a specific Hazardous Waste Hauler or to a scheduler.

It is contemplated that the foregoing system and components thereof may have industry wide application and value. When rolled out to a particular customer/entity, a provider of the waste logic 106 may first obtain a list of all products sold by the entity to create a universe of possible Damaged Products. Based on this universe, the product to SDS association logic 214 can be constructed to simply associate the appropriate SDS to each such product (i.e., Damaged Product). Similarly, with the product universe and corresponding SDS' identified, the SDS to waste information association logic 216 can also be constructed. SDS to waste information association logic 216 is constructed using the information provided on the SDS such that Damaged Products can be managed, sorted, stored and/or disposed of/treated in accordance with Health and Safety Laws and any other customer-specific and/or provider-specific (e.g., Hazardous Waste Hauler-specific) requests.

Among other advantages, the above method and apparatus provides a cost efficient and time efficient method of complying with Health and Safety Laws.

Other advantages will be recognized by one having ordinary skill in the art. It will also be recognized that the above description describes mere examples and that other embodiments are envisioned and covered by the appended claims. It is therefore contemplated that the present invention cover any and all modifications, variations or equivalents that fall within the spirit and scope of the basic underlying principles disclosed above and claimed herein.

1. A system comprising:
scanner logic operative to generate product ID information representative of a damaged product that contains one or more of solid waste and hazardous waste; and
waste logic operatively coupled to the scanner logic and operative to generate waste information based on the product ID information,
wherein the scanner logic is further operative to print a waste instruction label based on the waste information that instructs a user as to how to dispose of the damaged product.

2. The system of claim 1, wherein the waste logic further comprises routing logic operative to facilitate communication with the scanner logic.

3. The system of claim 1, wherein the waste logic further comprises scheduling logic operative to generate schedule information based on waste information to facilitate removal of the damaged product.

4. The system of claim 1, further comprising a plurality of waste containers to facilitate disposal of the damaged product.

5. The system of claim 1, wherein the waste instruction label includes indicia associated with one of a plurality of waste containers to facilitate safe disposal of the damaged product in the one of the plurality of waste containers.

6. The system of claim 1, wherein the waste logic further comprises damaged product to SDS association logic operative to generate SDS information for such damaged product based on the product ID information.

7. The system of claim 6, wherein the waste logic further comprises SDS to waste information association logic operative to generate the waste information based on the SDS information.

8. The system of claim 1, wherein the scanner logic is further operative to generate scanner device ID information.

9. An assembly comprising: a scanner device for generating product ID information of a damaged product, the scanner device including a scanner for reading an identifier on the damaged product, a printer and scanner logic for generating the product ID information from the identifier; and waste logic in communication with the scanner logic for generating waste information based on the product ID information; wherein the printer generates a waste instruction label based on the waste information.

10. The assembly of claim 9, further comprising scheduling logic for generating schedule information based on waste information to facilitate removal of the damaged product.

11. The assembly of claim 9, further comprising a plurality of waste containers to facilitate disposal of the damaged product.

12. The assembly of claim 9, wherein the waste instruction label includes an indicia associated with one of a plurality of waste containers to facilitate safe disposal of the damaged product in the one of the plurality of waste containers.

13. A method comprising: scanning an identifier on a damaged product; generating product ID information of the damaged product from the identifier in a scanner logic; generating waste information based on the product ID information in waste logic in operative communication with the scanner logic; and printing a waste instruction label based on the waste information to facilitate disposal of the damaged product.

14. The method of claim 13, further comprising scheduling removal of the damaged product based on the waste information in a scheduling logic.

15. The method of claim 13, further comprising applying the waste instruction label to the damaged product.

16. The method of claim 13, further comprising depositing the damaged product in one of a plurality of waste containers.

17. The method of claim 13, wherein the waste instruction label includes indicia associated with one of a plurality of waste containers to facilitate safe disposal of the damaged product in the one of the plurality of waste containers.

18. The method of claim 13, wherein the scanner logic is further operative to generate scanner device ID information.
